(19) United States
(12) Patent Application Publication
(10) Pub. No.: US 2008/0270716 A1
(43) Pub. Date: Oct. 30, 2008

(54) METHODS FOR ENHANCED FLIGHT DATA RECORDING

(75) Inventors: Jay P. Kurtz, Rochester, MN (US); Doyle J. McCoy, Rochester, MN (US); Aspen L. Payton, Byron, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/741,906

(22) Filed: Apr. 30, 2007

(51) Int. Cl. G06F 12/16

(52) U.S. Cl. 711/161

(57) ABSTRACT

Flight data indicating a history of what has happened in a virtual memory system's programs is recorded. Memory residency of symbolic information associated with the flight data and is determined, and a determination is made whether all items needed to record the symbolic information are available without disk reads in the virtual memory system. If all items needed to record the symbolic information are available in the virtual memory system without disk reads, the symbolic information is recorded in-line at the time of recording flight data. If all items needed to record the symbolic information are not available without disk reads, only the virtual memory handles are recorded in-line at the time of recording flight data. Memory residency and disk reads may be replaced with exceed resource capacity and of excess resource such that a determination is made as to excess resources needed to determine flight data items fully and a determination is made as to whether the excess resources needed are available in the virtual memory system for resolving the flight data items fully at the time of recording flight data.

### BACKGROUND

The present invention relates generally to data recording, and, more particularly to recording flight data.

Nearly all modern operating systems and program products/applications contain a plethora of tools in the forms of “flight records” and/or traces. That is, a “flight record” or trace is used in modern operating system to record a history of what has happened in the system's programs. A flight record typically contains only information that helps to identify the flow of the system's programs and status information.

Also, nearly all modern operating systems and program products are built on virtual memory architecture. One aspect of virtual memory based systems is that some information, at any given moment, may not be resident in main memory. To access such a non-resident data item, a disk read operation is typically required.

Common goals of most traces and flight records include efficiency, unobtrusiveness and minimization of “lost data”. These goals and the above-described nature of virtual memory systems are frequently at odds with one another.

What is needed, therefore, is a technique for flight recording or tracing that strikes a balance between a trace being low-impact and “getting good data”.

### SUMMARY

The foregoing discussed drawbacks and deficiencies and others are overcome or alleviated by methods for recording flight data according to exemplary embodiments.

According to one aspect, a method is provided for recording flight data indicating a history of what has happened in a virtual memory system's programs, the flight data having associated symbolic information. The method includes determining memory residency of the symbolic information associated with the flight data and determining whether all items needed to record the symbolic information are available without disk reads in the virtual memory system. If all items needed to record the symbolic information are available without disk reads, the symbolic information is recorded in-line at the time of recording flight data. If all items needed to record the symbolic information are not available without disk reads, only the virtual memory handles are recorded in-line at the time of recording flight data.

According to another aspect, a method for recording flight data items indicating a history of what has happened in a virtual memory system's programs is provided. The method includes determining excess of resources needed to determine flight data items fully and determining whether the excess of resources needed to determine the data item fully is available in the virtual memory system. If the excess of resources is available, the data item is determined fully in-line at the time of recording flight data item. If the excess of recourse is not available, determination of the data item fully is deferred.

### BRIEF DESCRIPTION OF THE DRAWINGS

Referring to the exemplary drawings wherein like elements are numbered alike in the several Figures:

FIGS. 1 and 2 illustrate exemplary methods for recording flight data according to exemplary embodiments.

### DETAILED DESCRIPTION

As explained above, it has historically been difficult to have a flight recorder/trace technique that can obtain good data without being obtrusive. For example, a flight recorder or trace, when implemented in the most efficient way, will usually only log the virtual memory “handles” for objects and data items it is monitoring. Frequently, these objects and data items have symbolic information associated with them (e.g., name, type, owner, birthday, etc.) that can be of great value during analysis of the collected data. Unfortunately, since this symbolic information is not usually needed by the application being monitored, the application (after start up) usually only uses virtual memory handles. In a virtual memory based system, this tends to make the symbolic information frequently not be resident in main memory.

So, the designer of the flight recorder or trace is faced with a difficult choice. The designer may resolve the symbolic information the first time it is needed, in-line with the flight recorder or trace, resolve the symbolic information the first item it is needed in a thread asynchronous to the flight recorder/trace, resolve symbolic information after the flight record or trace is completed or not resolve symbolic information. The designer may choose how to resolve/record symbolic information at start up time. All of these choices have advantages and disadvantages.

If the designer chooses to resolve the symbolic information the first time it is needed, in-line with the flight recorder or trace, this may slow down the operation of the flight recorder or trace if and when disk operations are required for resolution. If the designer chooses to resolve the symbolic information the first time it is needed, whether in-line with the flight recorder/trace or in a thread asynchronous the flight recorder/trace, this may impact the environment under test more than is “needed” by inducing extra disk operations that would normally not occur. If the designer chooses to resolve symbolic information after the flight recording/trace is completed, some if not most of the symbolic data may be lost, depending on the temporal nature of that data. Of course, if the designer decides not to resolve symbolic information at all, valuable information may be lost.

According to exemplary embodiments, a simple, balanced approach is provided for flight recording/tracing. An enhanced flight recorder/trace is provided that offers enhanced performance on virtual memory architectures. During a flight recorder/trace entry, a determination is made whether the symbolic information resides in main memory. If so, the information is recorded in-line. If not, only the virtual memory handles are recorded in-line, and the symbolic information for the handle is resolved upon completion of the flight recorder/trace operation.

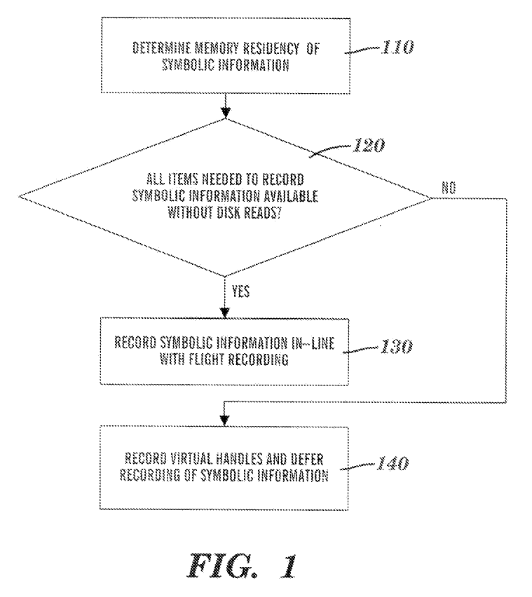

FIG. 1 illustrates an exemplary method for recording flight data according to one aspect. Referring to FIG. 1, during recording of a flight recorder or trace entry, the memory residency of the symbolic information may be queried (step 110). A determination is made at step 120 whether all the items that are needed to record the symbolic information are available without disk reads. It is the items that contain the symbolic info and any necessary items to link-to (find) the symbolic info. For example, a flight entry might contain the virtual memory handle of some piece of an object, like a file system file. To locate an record the symbolic information, it might be necessary to “touch” the beginning of the file, where perhaps a pointer to some symbolic information resides. Then one would have to “touch” the symbolic information itself to extract, perhaps, the name and/or path name. Both of these “touches” could incur page faults, resulting in disk reads.

If it is determined at step 120 that all the items that are needed are available without disk reads, the symbolic information may be recorded in-line with flight recording at that time at step 130. If any parts of the items needed are not resident in memory, only the virtual memory handles are recorded in-line at step 140, and the symbolic information is resolved (for this item) at a later time, e.g., after the flight record or trace is completed.

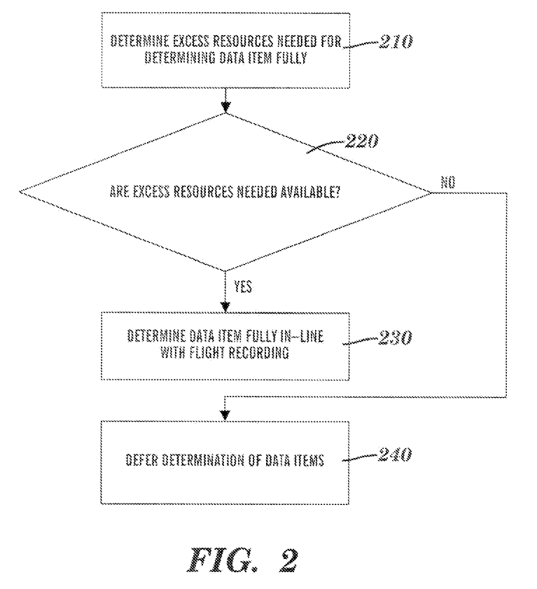

According to another aspect, “memory residency” and “disk reads” may be replaced with “instantaneous resource X excess capacity” and “using some resource X”. This is illustrated in FIG. 2, which shows an exemplary method for recording flight data according to a second aspect. In FIG. 2, a determination is made at step 210 as to the amount of excess resources needed to fully determine a data item. That is, a determination is made at step 210 as to the amount of excess resources needed to gather and record all the symbolic data associated with a data item that makes it most meaningful to an analyst.

For example, if the data item is the handle (address) of a program's instructions, it might take a burst of CPU to accurate locate the procedure and program the instruction belongs to and what “statement number” the instruction is associated with. This may involve scanning for procedure terminator strings and/or scanning of bit maps, both of which are CPU intensive operations.

A determination is made at step 220 as to whether the resources needed are available. If the excess resources are available, the data item is fully determined at step 230, in-line with the flight recording. Otherwise, determination of the data item is deferred at step 240, e.g., until after the flight recording ends or until extra resources become available.

For example, if a flight recorder entry needs a burst of CPU capacity to determine some data item (fully), the data item is determined in-line and concurrently with flight data recording only if there are extra CPU cycles available at that instant. Otherwise, determination of the data item is deferred until after the flight data recording ends, or until such time as extra CPU cycles are available.

While the invention has been described with reference to an exemplary embodiment or embodiments, it will be understood by those skilled in the art that various changes may be made and equivalents may be substituted for elements thereof without departing from the scope of the invention. For example, although the descriptions above is directed to flight recording/tracing, it should be appreciated that the invention may be applicable to any sort of data recording/tracing/logging that presents challenges similar to those described above. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention but that the invention will include all embodiments falling within the scope of the appended claims.

What is claimed is:

1. A method for recording flight data indicating a history of what has happened in a virtual memory system's programs, the flight data having associated symbolic information, the method comprising:
determining memory residency of the symbolic information associated with the flight data;
determining whether all items needed to record the symbolic information are available in the virtual memory system without disk reads;
if all items needed to record the symbolic information are available without disk reads, recording the symbolic information in-line at the time of recording flight data; and
if all items needed to record the symbolic information are not available without disk reads, recording only the virtual memory handles in-line at the time of recording flight data.

2. The method of claim 1, further comprising resolving the symbolic information after the recording of flight data is completed only if the virtual memory handles are recorded in line at the time of recording flight data.
